(19) United States
(12) Patent Application Publication
(10) Pub. No.: US 2011/0091749 A1
(43) Pub. Date: Apr. 21, 2011

(54) Battery Pack

(75) Inventor: Lu Chow, St. Gabriel, CA (US)

(73) Assignee: AC Propulsion, Inc.

(21) Appl. No.: 12/580,204

(22) Filed: Oct. 15, 2009

(51) Int. Cl. H01M 2/12

(52) U.S. Cl. 429/50; 429/53

(57) ABSTRACT

In a battery pack having a plurality of electrochemical battery cells arranged in one or more battery pack modules having inter-cell spaces defined between the cells, a method and apparatus diverts hot material vented from a failed battery cell into adjacent inter-cell spaces without permitting the hot material to directly impinge upon an adjacent battery cell end. Optionally the heat evolved from the cell failure is also conducted within the structure of the battery pack by thermally conductive elements to further dissipate it.

### TECHNICAL FIELD

The present disclosure relates generally to battery packs comprising a plurality of electrochemical battery cells.

### BACKGROUND

Electrochemical battery cells constructed in large arrays of individual cells (battery packs) are gaining popularity as a rechargeable power source for tools, vehicles and other powered devices. Some of these types of cells, such as Lithium ion (Li-ion) cells can experience failures leading to thermal runaway of other cells which can, in turn, cause damage to the battery pack and potentially to surrounding objects. For example, overcharging such a battery pack can lead to rising temperatures within individual cells and the battery pack overall, lithium plating within the cells, and formation of dendritic lithium within the cells which can cause internal shorts in individual cells. Such events can cause severe heating within the cells and an increase in internal pressure. For example, Li-ion cells containing Li—Co oxide (Lithium Cobalt oxide) cathodes may even catch fire when cell temperatures rise above about 150° C. Such damaging heat may be internally generated or externally applied. A cell having an internal short that leads to a temperature rise above 150° C., even locally inside the cell, may result in fire or explosion and cascading effects on nearby cells. Li-ion chemistries other than Li—Co oxide have different threshold temperatures for thermal runaway but are still subject to this potential failure.

To avoid such events, careful attention is given to the manufacture of the cells used in such battery packs as well as to the recharging and other interface electronics used with such battery packs. Nonetheless, given the large number of cells used in some battery packs, even with extremely low defect rates, cell failures will occasionally occur.

To relieve pressure in compromised cells, one or more pressure relief vent mechanisms are typically provided which vent hot materials from the cell at certain temperatures and/or pressures in order to relieve pressure within the cell and thus avoid an explosion. A problem with this approach is that when such vents open they release extremely hot materials such as gasses which can potentially direct excessive heat to adjacent cells within the battery pack causing a rapidly cascading failure. Such pressure relief vents generally comprise one or more apertures in the outer structure of the cell which may be coupled to a pressure relief valve of a type suitable for use in such cells. Such valves may include those of the type described in U.S. Pat. No. 7,195,839 where the vent aperture is formed by bursting a weakened portion of the cell container, those having a predefined aperture coupled to a pressure relief mechanism such as a valve or a burstable diaphragm or membrane, or the like.

To better understand the nature of the problem, the energy released during the combustion of a conventional Type 18650 3.6 V Li-ion battery cell having a 2.2 Ah capacity and 40 gram (g) weight built with 4 g of organic solvent in electrolyte and 7 g of graphite (carbon) in the anode is calculated as follows:
1. Electrolyte—the heat of combustion of solvents typically used in Li-ion cells are 1161 KJ/M for EC (ethyl carbonate, Molecular Weight (MW)=88.06), 2715 KJ/M for DEC (diethyl carbonate, MW=118.14), 1440 KJ/M for DMC (dimethyl carbonate, MW=90.08) and 2000 KJ/M for MEC (methyl ethyl carbonate, MW=104.11). A complete combustion of 4 grams of these solvents averages 71,600 joules.
2. Electric Energy—the electric energy available for release during fire/explosion is: 2.2A×3600 sec×3.6V=28,512 joules.
3. Graphite burning—the heat of combustion for graphite is 393 KJ/M. Complete combustion of 7 grams of graphite generates (393 KJ/M×7 g)/12 g/M=229,250 joules. Thus the total energy available is about 330 KJ. Among the components, organic solvent is relatively easy to burn completely, particularly when the cell is ruptured and opened to the air during the fire/explosion. Electric energy is difficult to completely release in the short duration of a fire/explosion. Graphite combustion can release the most energy. But it is difficult to burn and is difficult to burn completely when access to oxygen is limited as inside a cell.

If the energy released during fire/explosion is used to heat a single cell, the temperature rise of the cell can reach (40g cell weight, specific heat of cell is assumed to be 0.5 joule/g*° C.): 71,600/40×0.5=3580° C. by solvent combustion alone. Even higher temperatures can be reached if part of the electric energy is released.

In a battery pack constructed with many cells connected together, a single cell fire/explosion can, without proper precautions, easily cause one or more neighboring cells to reach their respective thermal runaway temperature, thus potentially spreading a fire or explosion until the whole battery pack is consumed.

Some cells are sealed with a plastic grommet, typically made of polypropylene, which can soften if even briefly exposed to temperatures significantly above 160° C., which will compromise the ability to seal and result in electrolyte leakage. This leakage in the neighborhood of a fire can quickly add fuel to the fire.

Many chemistries have been applied to Li-ion cells, e.g., Li—Co oxide, Li-Manganese oxide, Li-Iron phosphate, Li-Nickel oxide. Each chemistry has its own thermal runaway temperature ranging from 150° C. to 400° C. or higher. While some are higher, and thus potentially safer, the safety level accomplished by higher thermal runaway temperatures is limited because all Li-ion cells currently manufactured employ organic solvents as described above in the electrolyte and once that starts to burn even the higher thermal runaway temperatures can be readily achieved.

Accordingly it would be desirable to provide an apparatus and method to safely contain and manage a cell-failure in such a battery pack.

### Overview

In a battery pack comprising a plurality of electrochemical battery cells arranged in one or more battery pack modules having inter-cell spaces defined between the cells, a method and apparatus diverts hot material vented from a failed battery cell into adjacent inter-cell spaces without permitting the hot material to directly impinge upon an adjacent battery cell end. Optionally the heat evolved from the cell failure is also conducted within the structure of the battery pack by thermally conductive elements to further dissipate it.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a system block diagram of a typical system employing a battery pack to power a load.

FIG. 2 is a perspective drawing illustrating a battery pack module in accordance with one embodiment of the present invention.

FIG. 3 is an exploded view illustrating the assembly of a portion of the battery pack module of FIG. 2 in accordance with one embodiment of the present invention.

FIG. 4 is a close-up cut-away perspective view of a portion of the battery pack module of FIG. 2 in the closed position.

FIG. 5 is a different version of FIG. 4 showing the flow of expelled material from a failed cell.

FIG. 6 is a flow diagram illustrating the steps of a process in accordance with one embodiment of the present invention.

### DESCRIPTION OF EXAMPLE EMBODIMENTS

Example embodiments are described herein in the context of a battery for an electrically powered or partially electrically powered vehicle such as an automobile. Those of ordinary skill in the art will realize that the following description is illustrative only and is not intended to be in any way limiting. Other embodiments will readily suggest themselves to such skilled persons having the benefit of this disclosure. Reference will now be made in detail to implementations of the example embodiments as illustrated in the accompanying drawings. The same reference indicators will be used to the extent possible throughout the drawings and the following description to refer to the same or like items.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

As pointed out above, a major potential safety issue with battery packs, and particularly battery packs used in vehicles, is the potential for a single cell failure to cause a cascading failure in a number of other battery cells. In order to avoid that consequence, it is important to avoid having the heat from the single cell failure impinge directly upon a single or a few adjacent cells.

To thus ensure that the heat evolved from a single cell fire/explosion will not spread solely to the immediately neighboring cells, a battery pack in accordance with the present invention is designed in such a way that the energy released due to a cell failure is dissipated somewhere other than only in the immediately neighboring cells. If the place that the heat is dissipated has a large heat capacity, and can readily absorb the heat released, the temperature rise of adjacent cells will be reduced. Making use of the cells in the battery pack as a sink for the heat released is an economically practical approach. For example, if the energy of 71,600 joules is absorbed by 100 cells, then the temperature rise of these cells will become 3580° C./100=35.8° C. This temperature rise will raise the temperature from the typical battery operating temperature of about 40° C. or under to about 40° C.+35.8° C.=75.8° C., which is far from the thermal runaway temperature of Li-ion cells. The key to the success of this approach is to effectively spread the heat generated in a single-cell fire/explosion to many cells, and/or other battery pack structure and/or the environment.

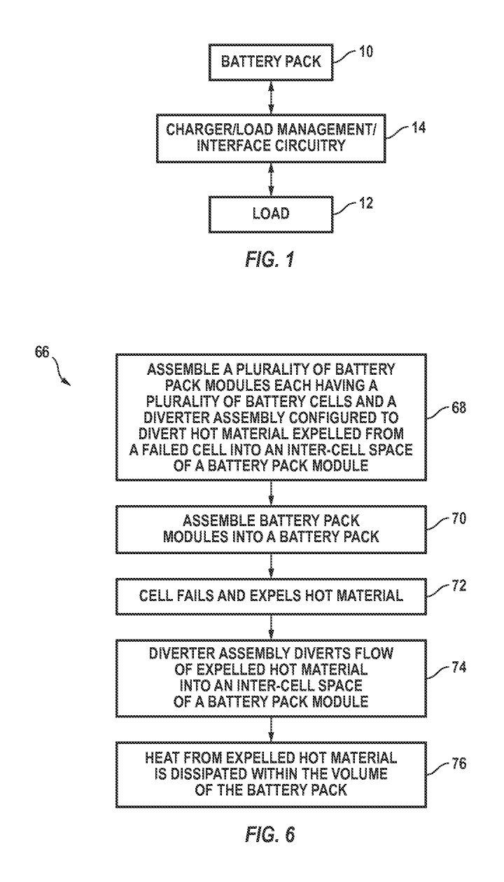

Turning now to the figures, FIG. 1 is a system block diagram of a typical system employing a battery pack to power a load. In accordance with FIG. 1, a battery pack 10 provides power to a load 12 through a block 14 which provides charger, load management (possibly including an inverter for AC loads) and interface circuitry functions. The system can be implemented, for example, in an electric vehicle (EV) such as an electric automobile, or in other equipment requiring a relatively large battery pack for power. The embodiment illustrated herein has been developed for use in such an EV, however, the invention is not intended to be so limited.

In one embodiment 53 commercial cylindrical Type 18650 batteries of 2.0 Ah capacity are connected in parallel to make a sub-module of 106 Ah/3.6V. These cells are designed with a crimp seal using plastic grommet as an insulator. The top is the positive end and is also where pressurized material will be ejected from in the case of a fire or explosion.

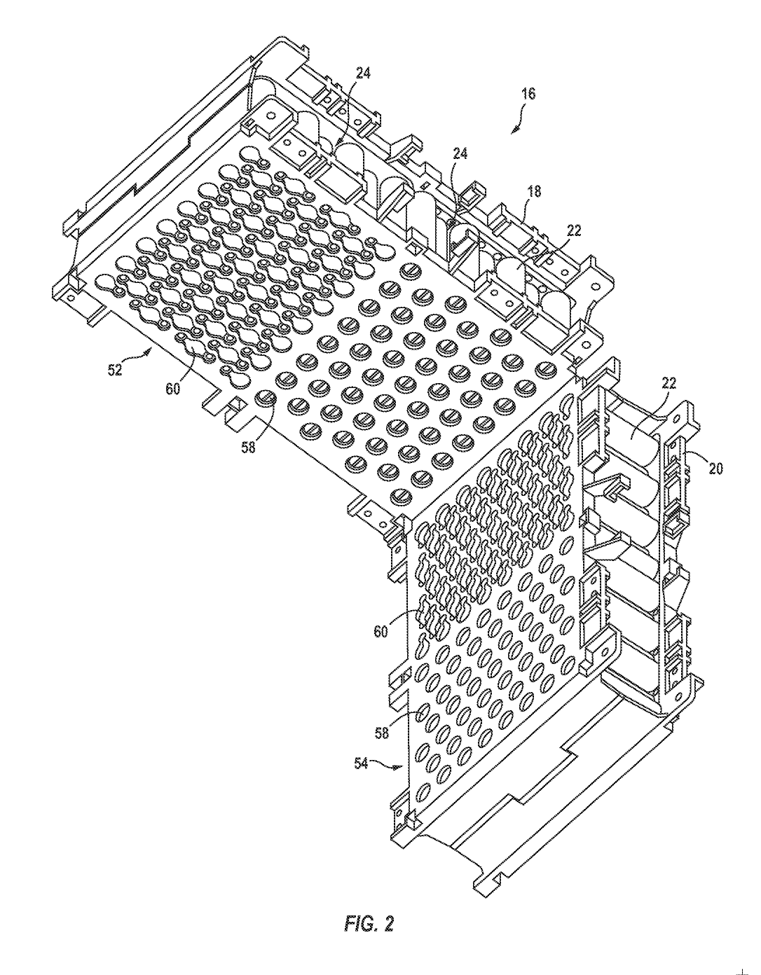

FIG. 2 is a perspective drawing illustrating a battery pack module in accordance with one embodiment of the present invention. The battery pack module 16 illustrated in FIG. 2 comprises a pair of (optionally hinged together) battery pack sub-modules 18 and 20 which are assembled together into a battery pack module. Each battery pack sub-module as shown includes 106 individual cells and the battery pack module includes a total of 212 individual cells in the embodiment shown. Other configurations can be developed in accordance with the intended application for the battery pack. In a typical EV application, a plurality of battery pack modules 16 would be assembled into a battery pack and series and parallel connected as required to yield the voltage and ampacity required by the specific application. As the individual battery cells 22 are cylindrical in this application (e.g., type 18650s) (although other shapes may also be used), they conveniently define an inter-cell space 24 between adjacent cells. A similar inter-cell space could be provided for differently shaped cells (such as rectangular solid cells) by adjusting the cell layout within battery pack module accordingly.

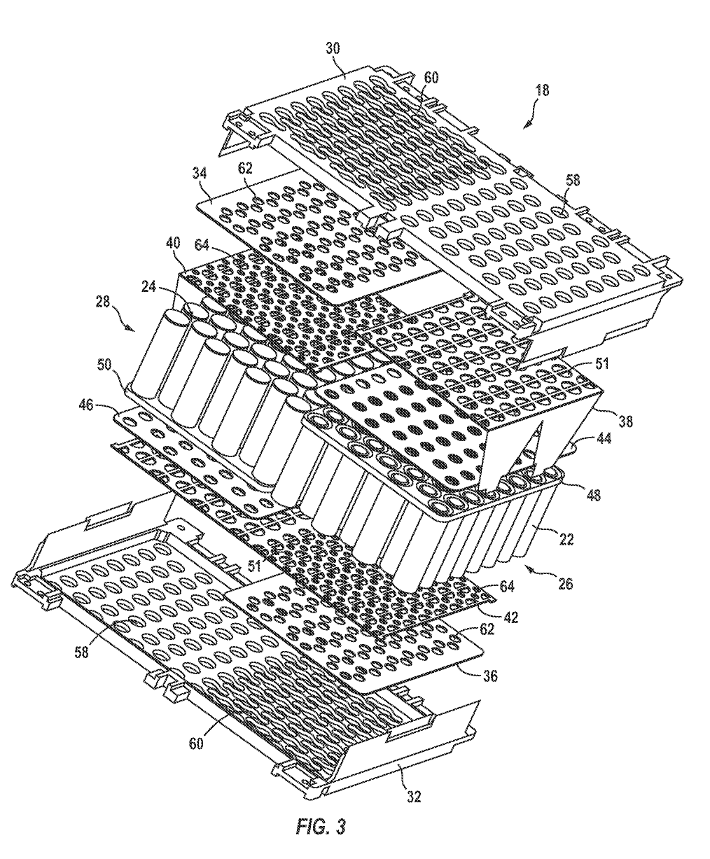

FIG. 3 is an exploded view illustrating the assembly of a portion of the battery pack module of FIG. 2 in accordance with one embodiment of the present invention. Shown here is battery pack sub-module 18. As can be seen from this view, the battery pack sub-module 18 is arranged so that a first group 26 of 53 of its cells have their positive terminal oriented in one direction while the second group 28 of 53 of its cells are oppositely oriented. The module comprises the following components: (1) upper non-conductive plastic outer case 30; (2) lower non-conductive plastic outer case 32; (3) upper negative-side insulating sheet 34 (formed of Nomex® in one embodiment of the present invention); (4) lower negative-side insulating sheet 36 (formed of Nomex® in one embodiment of the present invention); (5) positive sub-module output conductor 38 (formed of an electrically conductive material such as solder-plated copper which can be welded or soldered to individual cells; (6) negative sub-module output conductor 40 (formed of an electrically conductive material such as solder-plated copper which can be welded or soldered to individual cells; (7) intermediate conductor 42 which is connected to all cells (formed of an electrically conductive material such as solder-plated copper which can be welded or soldered to individual cells); (8) upper positive-side insulating sheet 44 (formed of Nomex® in one embodiment of the present invention); (9) lower positive-side insulating sheet 46 (formed of Nomex® in one embodiment of the present invention); (10) upper assembly casting layer 48 which holds the assembly of individual battery cells 22 in first group 26 together at their positive terminal ends and is, in one embodiment of the present invention, fabricated from a conventional resin casting although any suitable material may be used; (11) lower assembly casting layer 50 which holds the assembly of individual battery cells 22 in second group 28 together at their positive terminal ends and is, in one embodiment of the present invention, fabricated from a conventional resin casting although any suitable material may be used. As can readily be seen from FIG. 3, the conductor sheets 38, 40 and 42 are arranged with double “D”-shaped cut-outs over each cell. The center 51 of each double-“D” configuration is welded or soldered to its corresponding cell terminal (or otherwise electrically connected) to provide a reliable electric connection thereto. Appropriate conventional fasteners (not shown) are used to hold the sub-module assembly together, the sub-modules together into a battery-pack module, and the battery pack modules together into a battery pack.

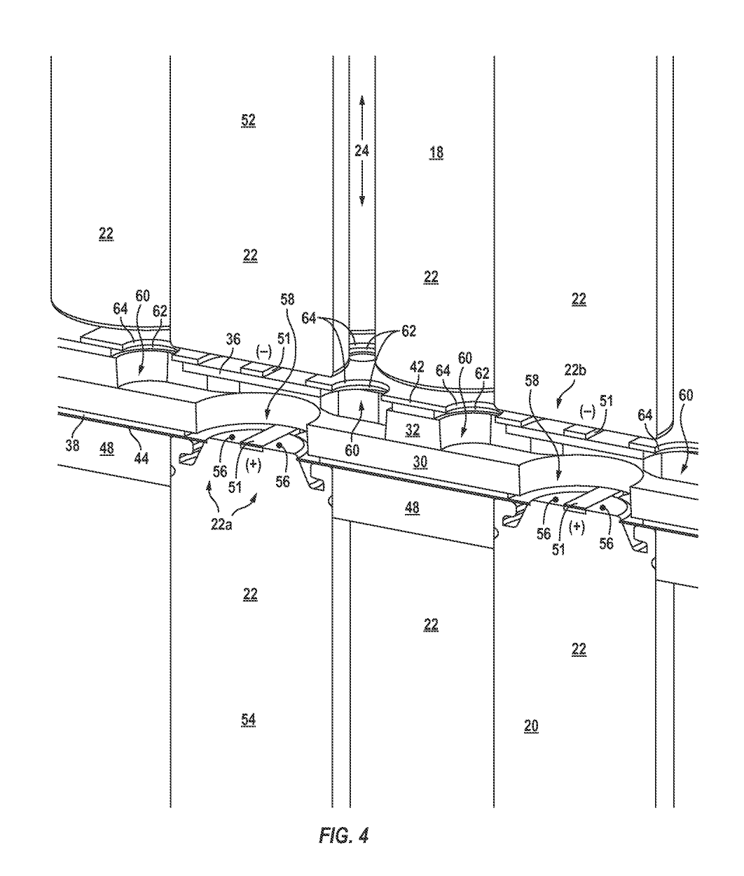

FIG. 4 is a close-up cut-away perspective view of a portion of the battery pack module of FIG. 2 in the closed position. Referring to FIG. 2, the view shown in FIG. 4 corresponds to battery pack sub-module 18 closed against battery pack sub-module 20 so that area 52 overlays area 54. Each battery cell 22 has a first end 22a and a second end 22b defining therebetween a longitudinal axis. Each cell 22 is provided with one or more pressure relief vents 56 at first end 22a which open in response to heat and/or pressure exceeding certain specified values. This results in venting hot material such as gasses and other internal combustion products due to a cell failure from that end. While the pressure relief vents 56 are shown at the positive ends of the cells in FIG. 4, there is no requirement that they be disposed at the positive end, but it is normally the case. The pressure relief vents 56 communicate with holes 58 in upper non-conductive outer case 30. Those holes 58, in turn, communicate with first diverter holes 60 located in the corresponding lower non-conductive outer case 32. Those first diverter holes 60, in turn, communicate with one or more second diverter holes 62 disposed in lower negative-side insulating sheet 36, which, in turn, communicate with third diverter holes 64 disposed in intermediate conductor 42 located adjacent to the negative terminals of battery cells 22 at one end of inter-cell space 24 defined by gaps between the cells 22 of the two-dimensional array of cells 22 as shown.

In operation, a cell failure results in the pressure relief vent(s) of a cell 22 opening and causing heated material to be released through pressure relief vents 56. The heated material travels through hole 58, into first diverter hole 60, through one or more second diverter holes 62, through third diverter holes 64 and into a corresponding inter-cell space 24 where it can dissipate into some or all of the rest of the battery pack without causing spot heating directly on an adjacent cell. Forced air ventilation is provided in one embodiment of the present invention which flows orthogonally to the longitudinal axes of the individual cells to remove normal heat dissipated in normal operation as well as a portion of the extraordinary heat caused by a cell failure venting heated material into the inter-cell spaces 24. Thus the inter-cell spaces 24 communicate with one another to allow this cross-flow forced air cooling in accordance with one embodiment of the present invention.

Those of ordinary skill in the art will now recognize, having the benefit of this disclosure, that other arrangements can be made to divert hot material vented from one end of the cells 22 into the inter-cell spaces 24, for example, the parts used could be combined into one or more assemblies fewer or more numerous than those illustrated herein.

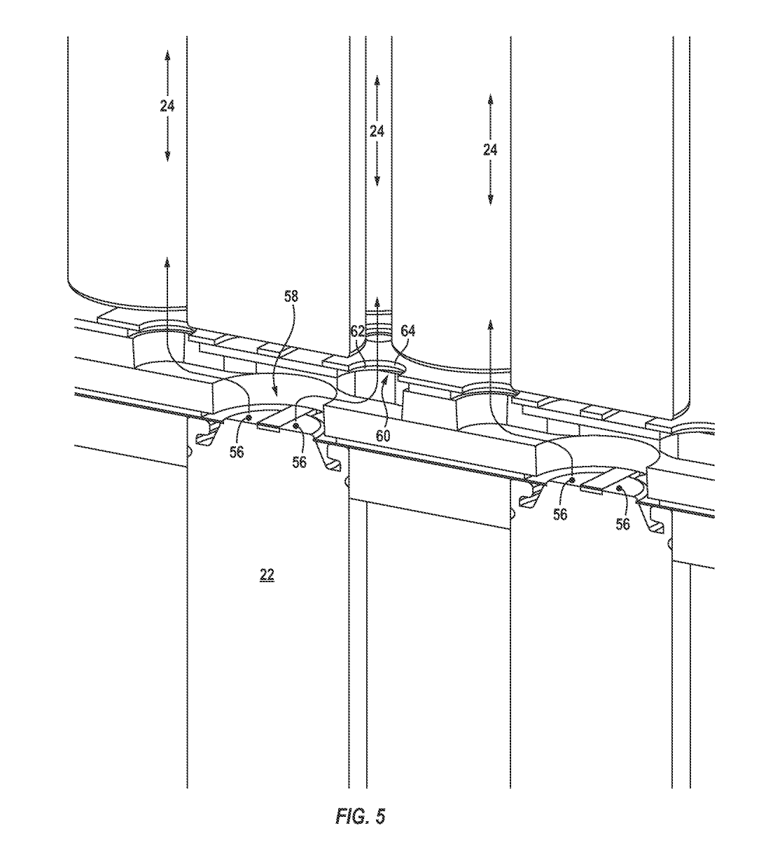

FIG. 5 is a different version of FIG. 4 showing the flow of expelled material from a failed cell. In essence, the diverter assembly comprising holes 58, 60, 62 and 64 acts to route hot material expelled from the cell in a failure event around the ends of adjacent cells and into an inter-cell space 24 defined by the adjacent cells as shown by the arrows in FIG. 5.

In accordance with another embodiment of the present invention, the case 30/32 may be fabricated of a thermally highly conductive material such as aluminum which will also act as a heat spreader to quickly spread heat due to a cell failure throughout a module and its adjacent module where it can be sinked by more of the battery pack. The thermal mass of the case 30/32 in accordance with this embodiment may be designed to better sink more heat (e.g., by adding mass, and/or finned heat sink areas) if required by the application. In the embodiment shown in FIGS. 4 and 5, changing the non-conductive case 30/32 to a conductive one should have no adverse effect on the design of the battery pack as insulating sheets 44/36 isolate the case from the conductors of the module.

In accordance with yet another embodiment of the present invention, the case portion 32 may be fabricated of aluminum and directly connected to the negative terminals of battery cells 22 thus eliminating the need for layers 36 and 42 and their corresponding diverter holes 62, 64. The thermal mass of the case 32 in accordance with this embodiment may be designed to better sink more heat (e.g., by adding mass, and/or finned heat sink areas) if required by the application.

FIG. 6 is a flow diagram illustrating the steps of a process or method 66 in accordance with one embodiment of the present invention. In accordance with this process or method 66, at block 68 one assembles a plurality of battery pack modules each having a plurality of battery cells and a diverter assembly configured to divert hot material expelled from a failed cell into an inter-cell space of a battery pack module. The battery pack module can be either the same or an adjacent battery pack module. At block 70 one assembles the battery pack modules into a battery pack comprising one or more battery pack modules. At block 72 a cell fails and expels hot material through vent aperture(s) in the cell. At block 74 the diverter assembly diverts the flow of expelled hot material into an inter-cell space of a battery pack module (which can be the same or an adjacent module). At block 76 heat from expelled hot material is dissipated within the volume of the battery pack and/or dissipated to the environment through ventilation.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted except in the spirit of the appended claims.

What is claimed is:

1. A battery pack, comprising:
a plurality of electrochemical battery cells each having
a longitudinal axis defined between a first end and a second end thereof, and
at least one pressure relief vent disposed at the first end;
a first group of the plurality of cells arranged in a 2-dimensional array with their longitudinal axes parallel to one another and first inter-cell spaces defined between them;
a second group of the plurality of cells arranged in a 2-dimensional array with their longitudinal axes parallel to one another and second inter-cell spaces defined between them;
a deflector assembly arranged between the first group of the plurality of cells and the second group of the plurality of cells and configured to deflect material vented from the pressure relief vents of the first group of the plurality of cells into the second inter-cell spaces.

2. The battery pack of claim 1, wherein the deflector assembly includes a thermally conductive member arranged to conduct heat transferred from the material vented from the pressure relief vent to a plurality of cells of at least the second group of the plurality of cells.

3. The battery pack of claim 2, wherein the thermally conductive member comprises metal.

4. The battery pack of claim 3, wherein the metal is aluminum.

5. The battery pack of claim 1, wherein the cells are rechargeable.

6. A battery pack, comprising:
a lower outer case assembly having a first surface;
an upper outer case assembly having a second surface;
a plurality of holes disposed through the second surface and through the upper outer case assembly;
at least one battery assembly having a plurality of electrochemical battery cells, the cells each having a first end and a second end and at least one pressure relief vent oriented to vent material in an over pressure condition of the cell in a direction away from the first end; and
a layer of electrically conductive material disposed adjacent to the second surface and electrically coupled to the plurality of cells, the layer of conductive material having a plurality of apertures disposed therethrough which are aligned with corresponding holes through the upper outer case assembly;
wherein the plurality of apertures and corresponding holes are oriented so that material vented away from the first end of a cell will pass through a corresponding aperture and hole.

7. The battery pack of claim 6, further comprising:
a layer of an electrically insulating material disposed between the cells and the layer of electrically conductive material.

8. The battery pack of claim 7, wherein the layer of electrically insulating material comprises heat and flame resistant fiber.

9. The battery pack of claim 8, wherein the heat and flame resistant fiber includes Nomex®.

10. The battery pack of claim 6, wherein the plurality of electrochemical battery cells include lithium ion battery cells.

11. The battery pack of claim 6, wherein the layer of conductive material comprises metal.

12. The battery pack of claim 11, wherein the metal is copper.

13. A battery pack, comprising:
at least two battery pack modules, each battery pack module including
a lower outer case assembly having an inner and an outer surface;
an upper outer case assembly having an inner and an outer surface;
a first plurality of holes disposed through the lower outer case assembly;
a second plurality of holes disposed through the upper outer case assembly;
at least one battery assembly having a plurality of electrochemical battery cells, the cells each having a first end and a second end, and at least one pressure relief vent oriented to vent material in an over pressure condition of the cell in a direction away from the first end, the cells oriented in a two-dimensional array defining inter-cell spaces;
a first layer of conductive material disposed adjacent to the inner surface of the upper outer case assembly and electrically coupled to the cells, the first layer of conductive material having a first plurality of apertures disposed therethrough which are aligned with corresponding holes of the second plurality of holes; and
a second layer of conductive material disposed adjacent to the inner surface of the lower outer case assembly and electrically coupled to the cells, the second layer of conductive material having a second plurality of apertures disposed therethrough which are aligned with corresponding holes of the first plurality of holes;
wherein holes of the first plurality of holes are arranged to communicate through corresponding aligned apertures of the second plurality of apertures with inter-cell spaces of the at least one battery assembly and with corresponding holes of the second plurality belonging to an adjacent battery pack so that material vented from a pressure relief vent of a cell will pass through at least one aperture of the first plurality of apertures through the first layer of conductive material and corresponding hole of the second plurality of holes through the upper outer case assembly of a first battery pack module and then through at least one hole of the first plurality of holes through the lower outer case assembly and aperture of the second plurality of apertures through the second layer of conductive material to a corresponding inter-cell space of a second battery pack module.

14. The battery pack of claim 13, further including a thermally conductive member arranged to conduct heat transferred from the material vented from the pressure relief vent of a cell of the first battery pack module to a plurality of cells of at least the second battery pack module.

15. The battery pack of claim 14, wherein the thermally conductive member comprises metal.

16. The battery pack of claim 15, wherein the metal is aluminum.

17. The battery pack of claim 16, wherein the cells are rechargeable.

18. A method comprising:
assembling a plurality of battery pack modules into a battery pack, each battery pack module having a plurality of electrochemical battery cells and the battery pack having a diverter assembly configured to divert hot material expelled from a failed cell into an inter-cell space of a battery pack module;
experiencing a cell failure resulting in hot material being expelled through a pressure relief vent of a failed cell;
diverting the hot material expelled from the pressure relief vent of the failed cell into an inter-cell space of a battery pack module; and
dissipating heat evolved from the failed cell within the volume of the battery pack.
